(19) United States
(12) Patent Application Publication
(10) Pub. No.: US 2016/0062726 A1
(43) Pub. Date: Mar. 3, 2016

(54) SHARED-DISPLAY SYSTEM, NON-TRANSITORY RECORDING MEDIUM STORING COMPUTER READABLE SHARED-DISPLAY CONTROL PROGRAM, SHARED-DISPLAY CONTROL METHOD, AND SHARED-DISPLAY DEVICE

(71) Applicant: Konica Minolta Inc., Tokyo (JP)

(72) Inventors: Shunsuke TAKAMURA, Tokyo (JP); Shinya OGINO, Tokyo (JP); Kazuma TAKEUCHI, Tokyo (JP); Ikuko TSUBOTANI, Tokyo (JP)

(21) Appl. No.: 14/830,159

(22) Filed: Aug. 19, 2015

(30) Foreign Application Priority Data
Sep. 3, 2014 (JP) 2014-178660

(51) Int. Cl. G06F 3/14; G06F 3/147

(52) U.S. Cl. CPC G06F 3/1454; G06F 3/1431; G06F 3/147

(57) ABSTRACT

A shared-display system in which a plurality of devices including at least a display unit is connected each other via a communication network is provided, wherein a first device in the plurality of devices includes: a control unit which sets each element to shared display in which an element displayed on a display unit of the first device is displayed on another device, and when an added element is displayed on the display unit of the first device, the control unit determines whether the added element is related to a shared-display element which has been set to the shared display, sets, to the shared display, the added element determined to be related to the shared-display element and displays the added element on a display unit of the other device.

The entire disclosure of Japanese Patent Application No. 2014-178660 filed on Sep. 3, 2014 including description, claims, drawings, and abstract are incorporated herein by reference in its entirety.

### BACKGROUND OF THE INVENTION

1. Technological Field

The present invention relates to a shared-display system, a non-transitory recording medium storing a computer readable shared-display control program, a shared-display control method, and a shared-display device, and more particularly, relates to a shared-display system in which a plurality of devices can display information, a non-transitory recording medium storing a computer readable shared-display control program which controls shared-display of information, a shared-display control method, and a shared-display device used for the shared-display system.

2. Background

Recently, by using a display screen which is available for a plurality users (hereinafter called as a shared screen), an electronic conference in which the discussion is conducted while information to be displayed (hereinafter called as an element), such as a file created by a predetermined application or a handwritten information, is displayed or the element is edited on the shared screen has been held. In the electronic conference, by successively displaying, on the shared screen, the element displayed on another computer device, it is possible to conduct a lively discussion.

### DESCRIPTION OF THE RELATED ART

Regarding a technique for sharing display with a plurality of devices (hereinafter referred to as shared-display), for example, JP 11-065975 A (U.S. Pat. No. 6,308,199 B1) discloses a technique that an application included in a computer is shared with a plurality of computers connected each other via a network, and in a system in which the display screen generated by the application is shared, a display control unit, included in the computer including the application to be shared, controls whether to display or hide, for each user, a window displayed during a screen shared with other computer is being displayed.

Furthermore, there is a technique that an element which a user wants to display is selected from the elements displayed on one's own computer device and sharedly displayed. For example, as a desktop sharing function by an application, such as the skype (registered trademark), when a window which a user wants to share is selected from the windows displayed on the screen of the computer device, only the element displayed on the window is sharedly displayed on other participants' application screen.

Generally, when an explanation is given in a conference or the like, a plurality of material including reference material besides explanatory material is used. Similarly, in an electronic conference, during a user makes an explanation displaying explanatory material on a shared screen, the user successively displays reference material on a display of the user's computer device or on a shared screen.

In this case, in a conventional system, in order for the reference material to be displayed on the shared screen, every time the reference material is displayed on the screen of the user's computer device, the user needs to perform the setting of the reference material to be sharedly displayed, and there is a problem that the setting takes time and the discussion is interrupted. On the other hand, when all of the information displayed on the screen of each participant's computer device is set so as to be sharedly displayed, problems, that the information which the participant does not want to show is displayed, or it is difficult to efficiently proceed the conference as a lot of materials are displayed on the shared screen, occur.

### SUMMARY

The present invention has been made in view of the foregoing problems, and a main object of the invention is to provide a shared-display system, a shared-display control program, and a shared-display control method which can efficiently display an element to be sharedly displayed.

To achieve the abovementioned object, according to an aspect, a shared-display system, reflecting one aspect of the present invention, in which a plurality of devices including at least a display unit is connected each other via a communication network, is provided, wherein a first device in the plurality of devices comprises: a control unit which sets each element to shared display in which an element displayed on a display unit of the first device is displayed on another device, and when an added element is displayed on the display unit of the first device, the control unit determines whether the added element is related to a shared-display element which has been set to the shared display, sets, to the shared display, the added element determined to be related to the shared-display element and displays the added element on a display unit of the other device.

To achieve the abovementioned object, according to an aspect, a non-transitory recording medium storing a computer readable shared-display control program which operates in a first device in a plurality of devices in a shared-display system in which the plurality of devices including at least a display unit is connected each other via a communication network, reflecting one aspect of the present invention, is provided, and the program causes the first device to execute: processing of setting each element to shared display in which an element displayed on a display unit of the first device is displayed on another device; processing of determining, when an added element is displayed on the display unit of the first device, whether the added element is related to a shared-display element which has been set to the shared display; and sharing processing of setting, to the shared display, the added element determined to be related to the shared-display element and displaying the added element on a display unit of the other device.

To achieve the abovementioned object, according to an aspect, a shared-display control method in a shared-display system in which a plurality of devices including at least a display unit is connected each other via a communication network, reflecting one aspect of the present invention comprises: executing, by a first device in the plurality of devices, processing of setting each element to shared display in which an element displayed on a display unit of the first device is displayed on another device; executing, by the first device, processing of determining, when an added element is displayed on the display unit of the first device, whether the added element is related to a shared-display element which has been set to the shared display; executing, by the first device, processing of setting, to the shared display, the added element determined to be related to the shared-display element and transmitting, to the other device, data of a display image of the added element or a file of the added element; and executing, by the other device, processing of displaying the added element on a display unit of the other device based on the received data of the display image of the added element or the received file of the added element.

To achieve the abovementioned object, according to an aspect, an information shared-display device used as a first device in a plurality of devices in a shared-display system in which the plurality of devices including at least a display unit is connected each other via a communication network, reflecting one aspect of the present invention comprises: a display unit; a communication unit; and a control unit which sets each element to shared display in which an element displayed on a display unit of the information shared-display device is displayed on another device, wherein when an added element is displayed on the display unit of the information shared-display device, the control unit determines whether the added element is related to a shared-display element which has been set to the shared display, sets, to the shared display, the added element determined to be related to the shared-display element and displays the added element on a display unit of the other device.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, and wherein:

FIGS. 1A and 1B are schematic diagrams illustrating a configuration of a shared-display system according to a first embodiment of the present invention;

FIGS. 2A and 2B are block diagrams illustrating a configuration of a computer device according to the first embodiment of the present invention;

FIG. 3 is a block diagram illustrating a configuration of a display device according to the first embodiment of the present invention;

FIG. 4 is a flowchart illustrating operation (shared-display setting processing) of the computer device according to the first embodiment of the present invention;

FIG. 5 is a flowchart illustrating operation (shared-display processing) of the computer device according to the first embodiment of the present invention;

FIG. 6 is a flowchart illustrating operation (window adding processing) of the computer device according to the first embodiment of the present invention;

FIG. 7 is a flowchart illustrating operation (display processing) of the display device according to the first embodiment of the present invention;

FIGS. 8A and 8B are diagrams illustrating an example of a screen displayed on the computer device and the display device according to the first embodiment of the present invention;

FIGS. 9A and 9B are diagrams illustrating another example of a screen displayed on the computer device and the display device according to the first embodiment of the present invention;

FIG. 10 is a flowchart illustrating operation (window adding processing) of a computer device according to a second embodiment of the present invention;

FIG. 11 is a flowchart illustrating operation (display processing) of a display device according to the second embodiment of the present invention;

FIGS. 12A and 12B are diagrams illustrating an example of a screen displayed on the computer device and the display device according to the second embodiment of the present invention;

FIG. 13 is a flowchart illustrating operation (window adding processing) of a computer device according to a third embodiment of the present invention;

FIG. 14 is a flowchart illustrating operation (display processing) of a display device according to the third embodiment of the present invention;

FIGS. 15A and 15B are diagrams illustrating an example of a screen displayed on the computer device and the display device according to the third embodiment of the present invention; and

FIGS. 16A and 16B are diagrams illustrating another example of a screen displayed on the computer device and the display device according to the third embodiment of the present invention.

### DESCRIPTION OF THE PREFERRED EMBODIMENTS

Hereinafter, an embodiment of the present invention will be described with reference to the drawings. However, the scope of the invention is not limited to the illustrated examples.

As described in the Background, in an electronic conference, during a user makes explanation displaying explanatory material on a shared screen, in general, the user successively display reference material on a display of the user's computer device or on a shared screen. In this case, with a conventional system, in order for the reference material to be sharedly displayed, it is required to set the reference material to the shared display, and which takes time. On the other hand, when all of the information displayed on the screen of each participant's computer device is set to the shared display, the information which the participant does not want to show, such as a desktop screen or contents of a folder when a file is searched for, is displayed, or a lot of materials are displayed on the shared screen, and it is difficult to efficiently proceed the conference.

Therefore, in an embodiment of the present invention, the setting of the shared display is inherited based on the relation of the element to be displayed. More specifically, when an element displayed on one's own computer device is displayed on a projector or a shared screen, in a shared-display system in which each element can be set to the shared display, an element newly displayed on the screen of the computer device is determined whether or not the element is related to the element which has been set to the shared display. Then, when the element is related to the element set to the shared display, the newly displayed element or the information to specify the element (a display screen of the element itself, a window opened by an application, a reduced image of the element, a list of the element, or the like) is sharedly displayed automatically.

In this manner, by sharedly displaying the element which is related to the element set to the shared display automatically, the user does not need to perform the setting of the shared display by oneself, and it is possible to improve convenience for the user. Furthermore, by not sharedly displaying the element which is not related to the element set to the shared display, it is possible to prevent the element which does not need to be displayed from being displayed.

### First Embodiment

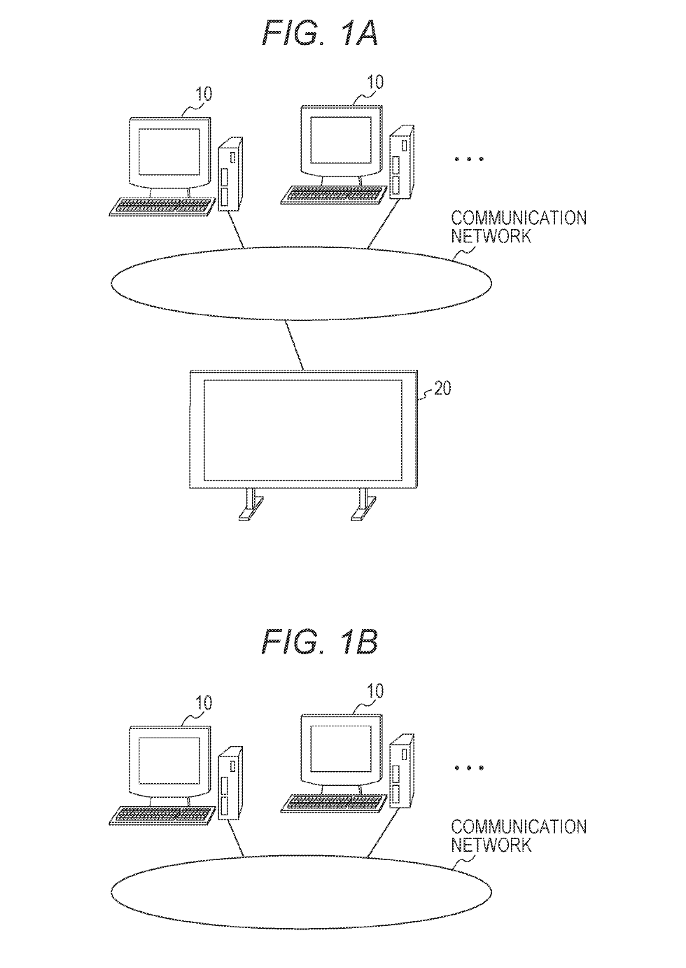

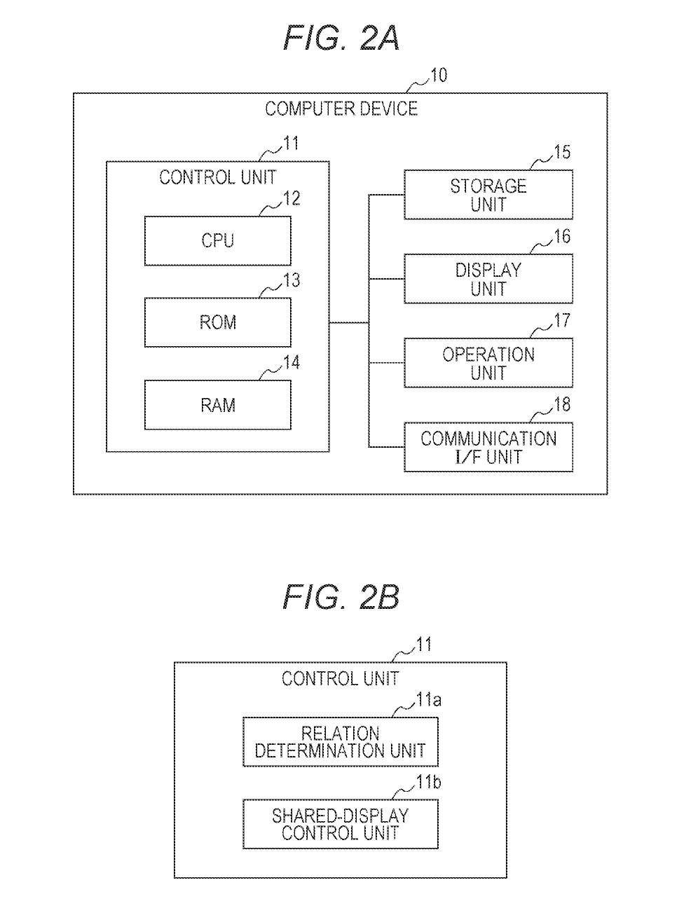

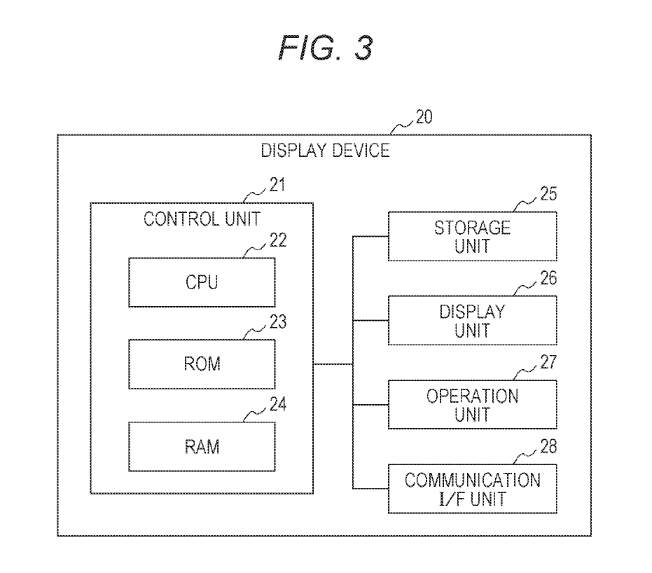

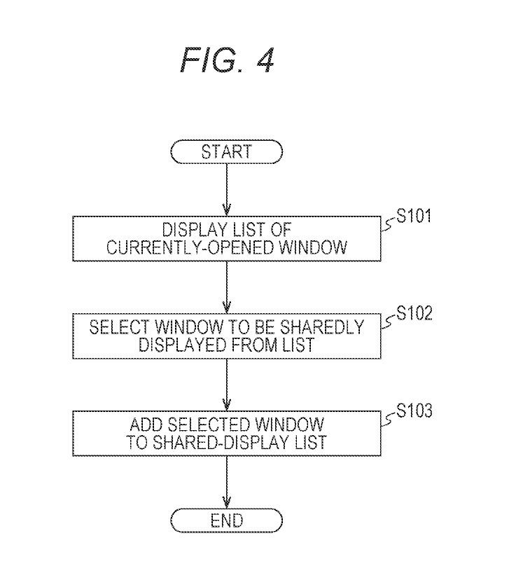

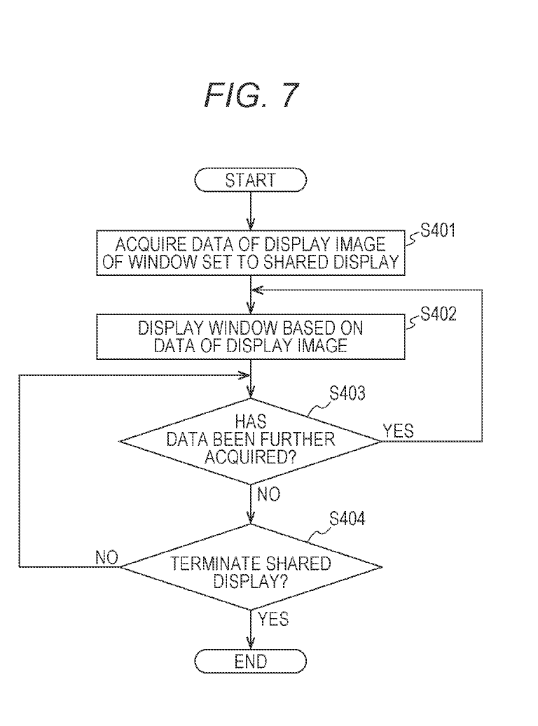

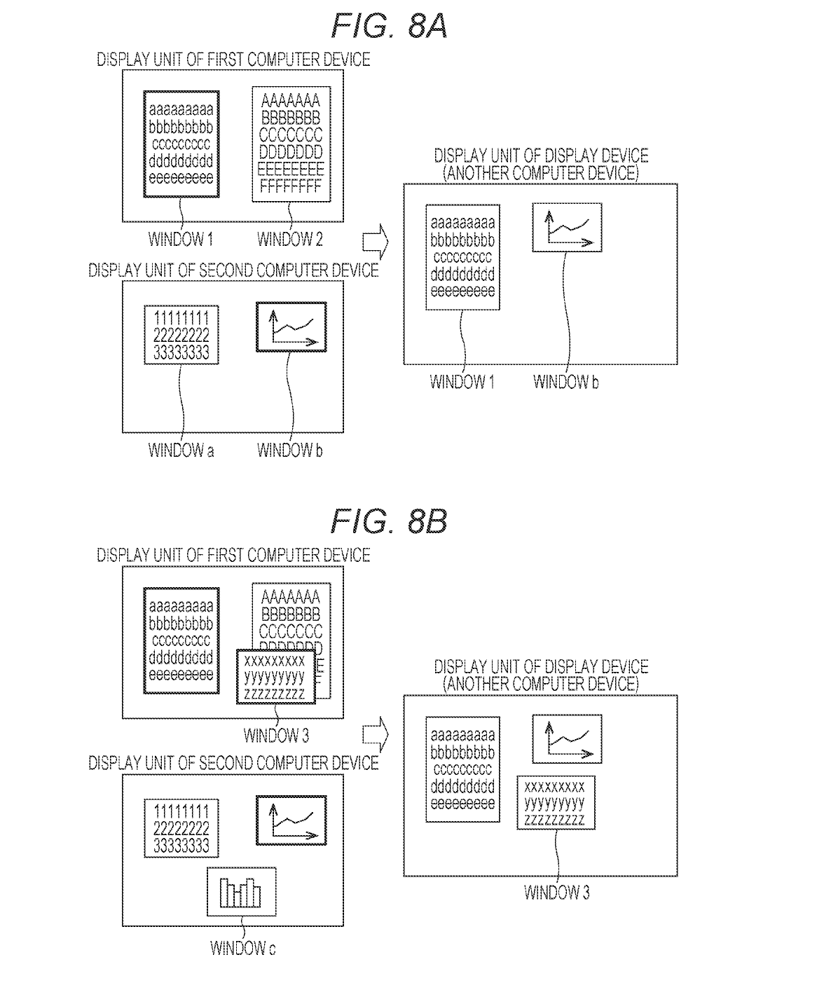

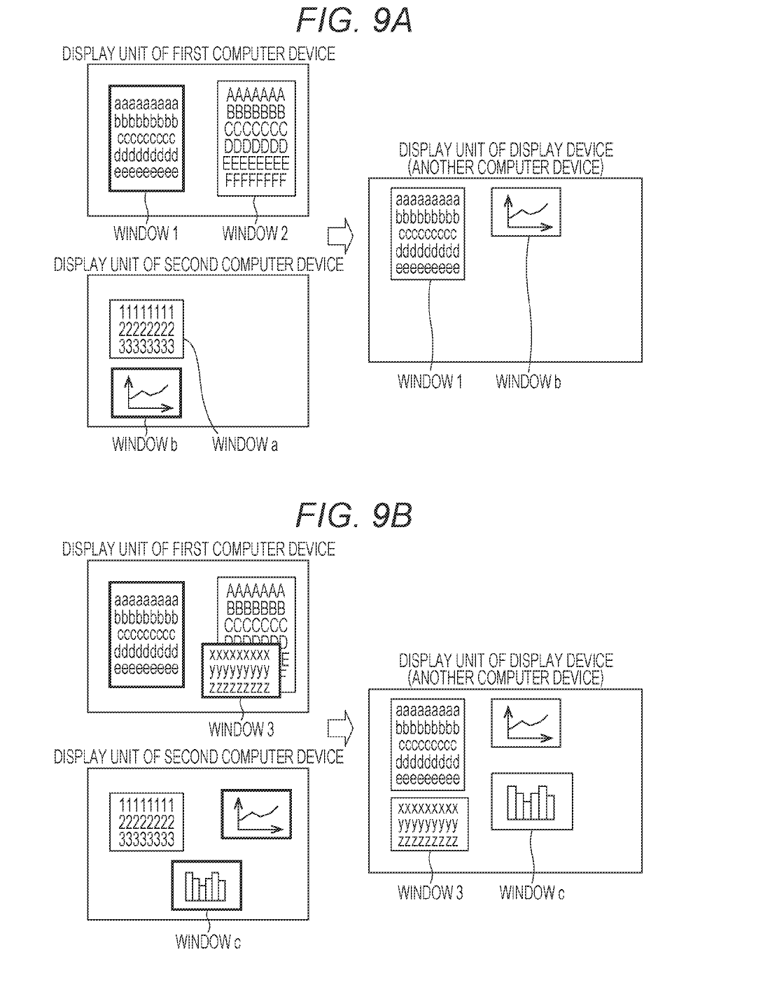

To describe in more detail an embodiment of the above described present invention, a shared-display system and a shared-display control program, and a shared-display control method according to a first embodiment of the present invention will be described with reference to FIGS. 1 to 9. FIGS. 1A and 1B are schematic diagrams illustrating a configuration of the shared-display system of the present embodiment, and FIGS. 2 and 3 are block diagrams illustrating configurations of the computer device and the display device respectively. FIGS. 4 to 6 are flowcharts illustrating operation of the computer device of the present embodiment, and FIG. 7 is a flowchart illustrating operation of the display device of the present embodiment. FIGS. 8 and 9 are diagrams illustrating an example of screens displayed on the computer device and the display device of the present embodiment.

Note that, in the following description, an element is information which is to be displayed and independently manageable, such as a document or an image created by using an application, or handwritten information handwritten on a touch panel. Furthermore, shared display indicates that the element (display image) displayed on a computer device 10 or information to specify the element (an image of a part of the display image, an image of the reduced display image, a name of the element, or the like) is displayed linked with at least another computer device 10 or a display device 20 (irrespective of the position or size on the screen).

As illustrated in FIG. 1A, the shared-display system of the present embodiment can set each element to the shared display, and includes one or more computer devices 10 which provide the element set to the shared display and the display device 20 which displays the element provided from the computer device 10. The one or more computer devices 10 and the display device 20 are connected each other via a communication network, such as a local area network (LAN) or a wide area network (WAN). Note that, although the computer device 10 and the display device 20 are distinguished in FIG. 1A, at least one of the computer devices 10, which are connected each other with a communication network, may provide the element set to the shared display and another at least one of the computer devices 10 may display the provided element (that is, functions as the display device 20), as illustrated in FIG. 1B. To simplify the description, the following description is based on the assumption of the configuration of FIG. 1A.

[Computer Device]

The computer device 10 is a mobile terminal, such as a personal computer, a tablet terminal, a smart phone, and includes a control unit 11, a storage unit 15, a display unit 16, an operation unit 17, and a communication I/F unit 18, as illustrated in FIG. 2A. At least one of the computer devices 10 functions as the shared-display device and transmits necessary information to another computer device, which will be described later, thus an image is sharedly displayed on a display unit of each computer device included in the shared-display system.

The control unit 11 includes a central processing unit (CPU) 12, and a memory, such as a read only memory (ROM) 13 and a random access memory (RAM) 14. The CPU 12 calls a control program from the ROM 13 or the storage unit 15, and expands and executes the program in the RAM 14, whereby the CPU 12 controls the operation of the entire computer device 10 and operates an application (document creation software, spreadsheet software, presentation software, image creation/edition software, or the like) on the operating system (OS).

Furthermore, the control unit 11 also functions as a relation determination unit 11a and a shared-display control unit 11b as illustrated in FIG. 2B.

The relation determination unit 11a monitors the operation of the operation unit 17, and when the operation to display a new element (hereinafter called as an added element) on the display unit 16 is performed, the relation determination unit 11a compares the added element with the element which has been set to the shared display (hereinafter called as a shared-display element) and determines whether the added element is related to the shared-display element. For example, when the file of the added element and the file of any of the shared-display element are stored in the same folder, the added element is determined to be related to the shared-display element. Furthermore, when file names of the added element and any of the shared-display element include a common keyword (including the same character string in the file names other than the extensions), the added element is determined to be related to the shared-display element. When an access right is set to each element and the access right of the added element is included in the range of the access right of the shared-display element, the added element is determined to be related to the shared-display element. When the added element is a link destination of any of the shared-display element, the added element is determined to be related to the shared-display element. When the added element is the information searched for by using a keyword included in any of the shared-display element, the added element is determined to be related to the shared-display element. When the added element and any of the shared-display element are displayed within a predetermined area of the display unit 16 (that is, the display positions are close), the added element is determined to be related to the shared-display element. Moreover, when the added element and any of the shared-display element are displayed during a predetermined period (that is, the display times are close), the added element is determined to be related to the shared-display element.

The shared-display control unit 11b generates display images of the shared-display element set to the shared display in advance and the added element determined to be related to the shared-display element by the relation determination unit 11a, and transmits the generated data of the display images via the communication I/F unit 18 to the display device 20 (or another computer device 10). Note that, when the added element is a document consisting of a plurality of pages and a predetermined page of the document is displayed on the display unit 16, the display image is the page image of the above predetermined page (however, the display size or the aspect ratio of the page, or the display area of the page may be different). Furthermore, when the added element is handwritten information consisting of a plurality of objects (such as characters, drawings, or images) and a predetermined area of the handwritten information is displayed on the display unit 16, the display image is the handwritten image inside the area (however, the display size or the aspect ratio of the area may be different).

The above relation determination unit 11a and shared-display control unit 11b may be configured as hardware, or the control unit 11 may be configured as software (shared-display control program) to function as the relation determination unit 11a and the shared-display control unit 11b, and the CPU 12 may execute the shared-display control program.

The storage unit 15 is configured with a memory, a hard disk drive (HDD), a solid state drive (SSD), or the like and stores the file of the element displayed on the display unit 16 or the data of the display image, the setting information of the shared display (such as a shared-display list, which will be described later) and the like.

The display unit 16 is configured with a liquid crystal display (LCD), an electro luminescence (EL) display, or the like and displays various elements. The operation unit 17 is configured with a mouse, a keyboard, a touch sensor formed of lattice electrodes disposed on the display unit 16, or the like and receives operation of an application, creation/display operation of the element, setting operation of the shared display, and the like.

The communication I/F unit 18 is configured with a network interface card (NIC), a modem, or the like, establishes the communication with another computer device 10 or the display device 20 which are connected via a communication network, and transmits the data of the display image generated by the shared-display control unit 11b to the display device 20 (or another computer device 10).

[Display Device]

The display device 20 is a display panel, or an electronic blackboard, or the like which has an arithmetic function and includes a control unit 21, a storage unit 25, a display unit 26, an operation unit 27, and a communication I/F unit 28 as illustrated in FIG. 3.

The control unit 21 includes a memory, such as a CPU 22, a ROM 23, and a RAM 24. The CPU 22 calls a control program from the ROM 23 or the storage unit 25, and expands and executes the program in the RAM 24, whereby the CPU 22 controls the operation of the entire display device 20. Furthermore, the control unit 21 generates, based on the data of the display image received form the computer device 10, a screen to display the shared-display element and the added element related to the shared-display element on the display unit 26. Then, when the contents of the shared-display element and the added element are edited, the control unit 21 transmits the edited shared-display element or the edited file of the added element to the computer device 10 as a display source.

The storage unit 25 is configured with a memory, a HDD, an SSD, or the like and stores the data of the display image received from the computer device 10, the edited shared-display element, the edited file of the added element, and the like.

The display unit 26 is configured with an LCD, an organic EL display, or the like and displays the shared-display element or the added element. The operation unit 27 is configured with a mouse, a keyboard, a touch sensor formed of lattice electrodes disposed on the display unit 26, or the like, provided as needed, and receives a changing instruction (such as movements or enlargement/reduction) of the display form of the shared-display element or the added element, or an editing instruction (such as addition or erasure of the information).

The communication I/F unit 28 is configured with a NIC, a modem, or the like, establishes the communication with the computer device 10 connected via a communication network, receives the data of the display image from the computer device 10, and transmits the edited shared-display element or the edited file of the added element to the computer device 10.

Note that, FIGS. 1 to 3 illustrate an example of the shared-display system of the present embodiment, and the configuration and control content thereof can be appropriately changed. For example, in FIGS. 1A and 1B, each computer device 10 generates the display image and transmits the image to the display device 20 (or another computer device 10), and the display device 20 (or another computer device 10) generates the display screen based on the data of the display image. However, a server connected to the communication network receives the data of the display image from each computer device and generates the display screen in which the data is integrated and transmits the display screen to each computer device 10 or the display device 20, and each computer device 10 or the display device 20 may display the received display screen as it is.

Hereinafter, the operation of the computer device 10 having the above configuration will be described. The CPU 12 of the computer device 10 as a display source (the computer device 10 which provides the element to be sharedly displayed) expands and executes, in the RAM 14, a shared-display control program stored in the ROM 13 or the storage unit 15, and whereby the CPU 12 executes the processing in each step illustrated in the flowcharts of FIGS. 4 to 6. Note that, in the following procedures, the element to be displayed will be described as an area (window) where information generated by an application is displayed.

[Shared-Display Setting Processing]

As illustrated in FIG. 4, the control unit 11 specifies the window currently displayed on the display unit 16 (the window opened with the application) and displays a list thereof (S101). Then, the control unit 11 allows a user to operate the operation unit 17 and select the window to be sharedly displayed from the list (S102). Thereafter, the control unit 11 adds the selected window to a shared-display list which is prepared in advance (S103).

[Shared-Display Processing]

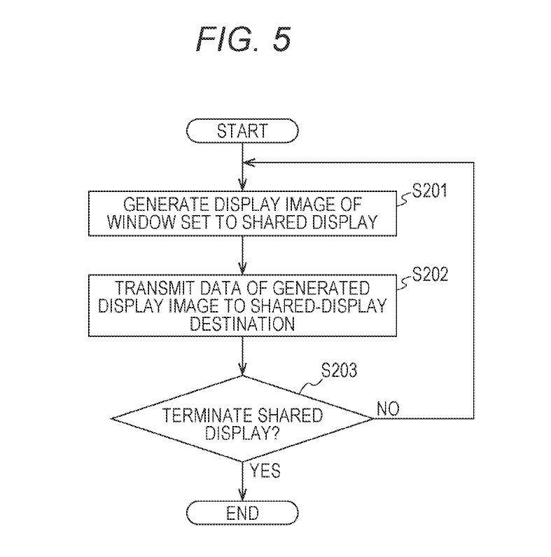

As illustrated in FIG. 5, the control unit 11 (the shared-display control unit 11b) specifies the window set to the shared display (the window listed in the shared-display list), generates the display image of the window (S201), and transmits the data of the generated display image to the display device 20 (or another computer device 10) as a shared-display destination (S202). More specifically, when the window is opened by document creation software, spreadsheet software, presentation software, or the like, the control unit 11 generates the image of the page displayed in the window (when apart of page is displayed, the part of the image). Furthermore, when the window is opened by handwritten software, the control unit 11 generates the image of the handwritten information handwritten inside the window. Then, the control unit 11 determines whether there is an instruction to terminate the shared display (S203), and repeats the processing of S201 and S202 until the instruction to terminate the shared display is received.

[Window Adding Processing]

While the above shared display is being performed, when a new window is displayed on the display unit 16 of the computer device 10 as a shared-display source (Yes in S301), the control unit 11 (the relation determination unit 11a) determines whether the new window is related to the window which has been sharedly displayed (S302). The method for determining the relation will be described later. Then, when the new window is related to the sharedly displayed window (Yes in S303), the control unit 11 (the relation determination unit 11a) sets the new window to the shared display (lists the new window in the shared-display list) (S304), and the control unit 11 (the shared-display control unit 11b) generates the display image of the new window and transmits the data of the generated display image to the display device 20 (or another computer device 10) as the shared display (S305).

Note that, in the above described procedures, when the new window is related to the sharedly displayed window, the new window is immediately set to the shared display. However, by displaying a pop-up screen before the window is set to the shared display, the control unit 11 may allow a user to confirm whether or not the window is set to the shared display.

Next, the operation of the display device 20 (or another computer device 10) will be described. The CPU 22 of the display device 20 expands and executes, in the RAM24, a control program stored in the ROM 23 or the storage unit 25, and whereby the CPU 22 executes the processing in each step illustrated in the flowchart of FIG. 7. Note that, in the following procedures, the element to be displayed will be described as the window.

First, the control unit 21 acquires the data of the display image of the window set to the shared display via the communication I/F unit 28 from the computer device 10 as the display source (S401), and displays the window set to the shared display on the display unit 26 based on the acquired data of the display image (S402).

Thereafter, when the control unit 21 monitors the reception of the data from the computer device 10 as the display source and further acquires the data of the display image (Yes in S403), the control unit 21 returns back to S402. Then, the control unit 21 acquires the added data of the display image (S401) and displays, on the display unit 26, the window (that is, the window determined to be related the sharedly displayed window) newly set to the shared display based on the acquired data of the display image (S402). When the control unit 21 has not received the data from the computer device 10 as the display source, the control unit 21 determines whether there is an instruction to terminate the shared display (S404) and monitors the reception of data until the instruction to terminate the shared display is received.

Next, the method for determining the relation will be described in detail. The methods for determining the relation between the newly added element and the sharedly displayed element are as follows.

A first method for the determination is based on the storage location of the file of the element. The materials to be used in the conference are generally organized in one folder to be easily managed. Therefore, when the file of the added element is stored in the same folder as any one of the files of the sharedly displayed elements, it is determined that the elements are related to each other. Furthermore, a shared file may be stored in, for example, a server. Therefore, when the file of the added element is stored in the same drive as any one of the files of the sharedly displayed elements, it is determined that the elements are also related. Note that, the storage location of the file can be specified by acquiring a file path, and by comparing the file paths, it can be determined that the storage location of the files is same.

A second method for the determination is based on the file name. The files on the same theme generally have a common keyword, such as a theme name, in a file name. Therefore, when the file names of the added element and any one of the sharedly displayed elements include the common keyword (for example, the file name of the added element is “oo report.ppt”, and the file name of the sharedly displayed element is “oo search result.xls”), it is determined the elements are related to each other. Note that, the file name can be specified by acquiring a file path, and by comparing the character strings of the file paths, it can be determined that the common keyword is included.

A third method for the determination is based on the access right of the file. The same access right is generally set to the files to be used in the same conference. Therefore, when the access right of the file of the added element is matched with that of any one of the sharedly displayed elements, it is determined the elements are related to each other. Note that, the access right of the file can be specified by acquiring a file property. Furthermore, when the access rights are not perfectly matched, but all of the sharing users are included in the access rights, it can be determined that the file is opened to be shared. Therefore, when the access right of the file of the added element includes the access right of the file of any one of the sharedly displayed elements, it is determined the elements are related to each other. More specifically, (1) the access right of the file of each sharedly displayed element (a user or a group which can access the file) is specified, (2) whether the access right of the file of the added element includes the access right of the file of any of the sharedly displayed elements is determined, and (3) when the inclusion is determined, the added element is determined to be related and set to the “shared display”.

A fourth method for the determination is based on operation contents of an application. In this case, the shared-display control program needs to acquire the operation contents of each application. More specifically, there is a case where link information (for example, a Hyperlink) to a supplementary material or a reference material is set in the materials. Thus, when a new element is displayed based on the link in the sharedly displayed element, the new element is determined to be related and set to the “shared display”.

A fifth method for the determination is also based on the operation contents of the application. More specifically, there is a case where a keyword which appears in the materials may be searched for in detail thereof in a Web and the like. Thus, the element, which is used when the keyword extracted from the sharedly displayed element is copied and pasted in a search window of a Web to be searched for (searched with a keyword), is determined to be related to the sharedly displayed element and set to the “shared display”.

A sixth method for the determination is based on the display position. When a plurality of elements is displayed on the computer device 10, the elements are generally displayed close to each other to be easily compared. Therefore, when the display positions of the elements are within a predetermined distance range, the elements are determined to be related and set to the “shared display”.

A seventh method for the determination is based on the display timing. When a plurality of elements is displayed on the computer device 10, the display times of the related elements are close to each other. Therefore, when the display timings are within a predetermined time range, the elements are determined to be related and set to the “shared display”.

Note that, the methods for determining the relation between the newly added element and the sharedly displayed element are not limited to the above seven methods, and an arbitrary method which can determine a reasonable relation can be applicable.

Hereinafter, the concrete method for the shared display will be described with reference to the drawings.

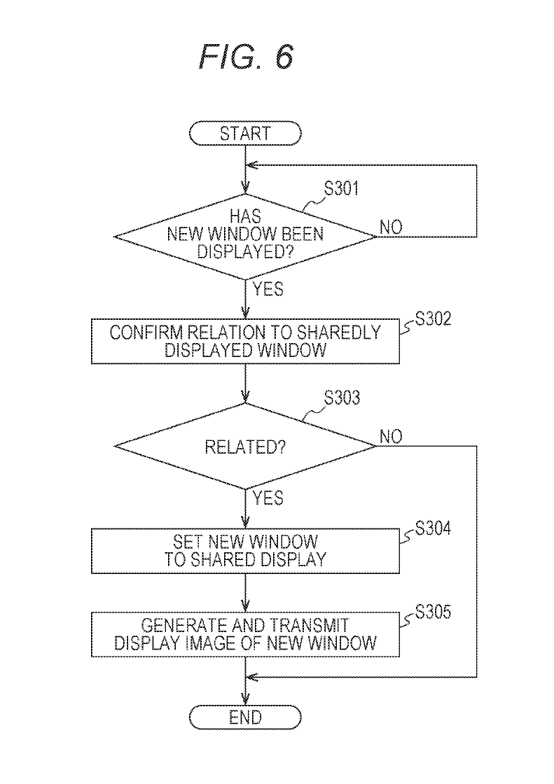

FIGS. 8A and 8B schematically illustrate the method for controlling the shared display according to the flowcharts of FIGS. 6 and 7. The left diagrams of FIG. 8A illustrate the screen of the display unit 16 of each computer device 10 as the display source (here, two computer devices 10). Rectangular frames in the screens indicate the elements (windows), and especially, rectangular frames in bold line indicate the windows set to the shared display (here, a window 1 and a window b). In this state, the window set to the shared display in the windows displayed on the display unit 16 of each computer device 10 is displayed on the display unit 26 of the display device 20 (or the display unit 16 of another computer device 10 set to the shared screen).

FIG. 8B illustrates that a new element (window) is added to the display unit 16 of the computer device 10 as the shared-display source. More specifically, a window 3, which is the document created with document creation software, is newly displayed on the display unit 16 of a first computer device 10. The window 3 is determined to be related to the window 1, set to the shared display, and also displayed on the display unit 26 of the display device 20 (or the display unit 16 of another computer device 10). On the other hand, a window c, which is the graph created with spreadsheet software, is newly displayed on the display unit 16 of a second computer device 10. However, the window c is determined not to be related to the window b, and is not displayed on the display unit 26 of the display device 20 (or the display unit 16 of another computer device 10).

Note that, although the frames of the windows are displayed in order to easily understand the element to be sharedly displayed in FIGS. 8A and 8B, these frames of the windows does not need to be displayed and the contents of the window (objects) may be displayed on the display unit 26 of the display device 20 (or the display unit 16 of another computer device 10). Furthermore, although the first computer device and the second computer device are exemplified as the computer device 10 as the shared-display source in FIGS. 8A and 8B, the computer device as the shared-display source may be one or more.

Moreover, although the element is displayed on the display unit 26 of the display device 20 (or the display unit 16 of another computer device 10) while the form (the position or the size) displayed on the computer device 10 as the shared-display source is being held in FIGS. 8A and 8B, the display position or the display size of each element can be set arbitrarily. For example, as illustrated in FIG. 9A, when the window 1 of the first computer device 10 and the window b of the second computer device 10 are set to the shared display, the size of the window 1 may be reduced to be displayed, and the display position of the window b may be changed to be displayed. Furthermore, as illustrated in FIG. 9B, when the window 3 is added to the first computer device 10 and the window c is added to the second computer device 10, and these windows are set to the shared display, the display position or the display size may be changed to be displayed.

As described above, in the shared-display system in which the element displayed on the display source can be independently set to the shared display, and the element set to the shared display is displayed on the display destination, when the element is newly added to the display source, it is determined whether the element is related to the sharedly displayed element. Then, when the element is determined to be related, the added element is sharedly displayed on the display destination automatically. Therefore, the user does not need to set each element to the shared display and it is possible to remarkably improve the user's operability.

### Second Embodiment

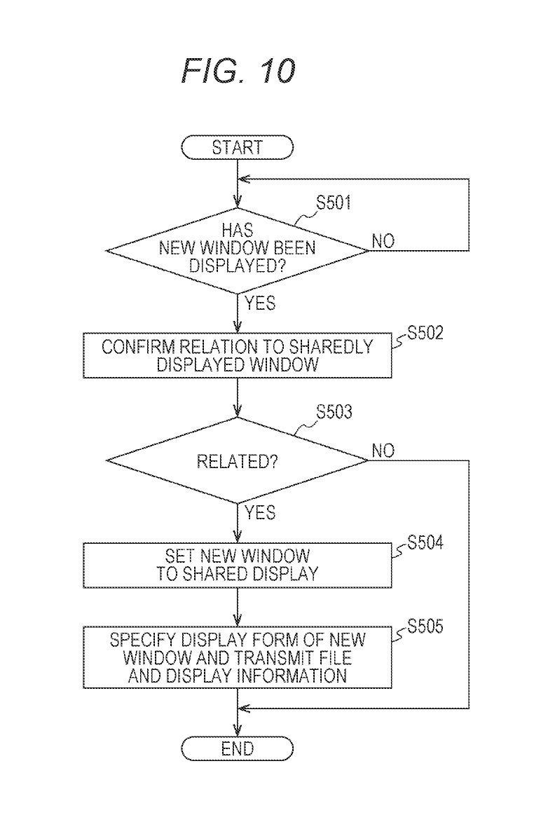

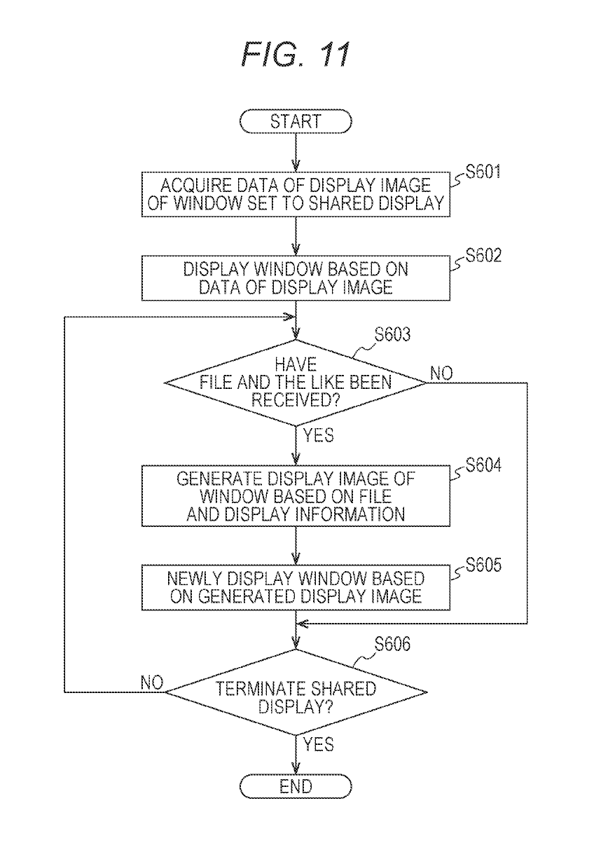

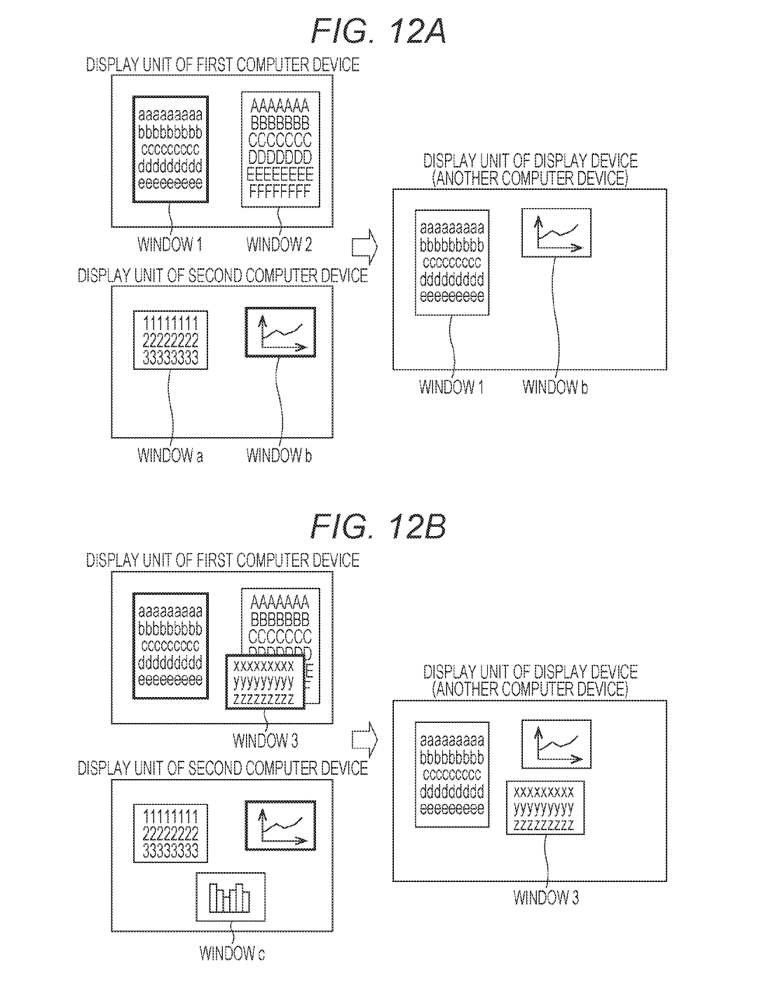

Next, a shared-display system and a shared-display control program, and a shared-display control method according to a second embodiment of the present invention will be described with reference to FIGS. 10 to 12. FIG. 10 is a flowchart illustrating operation of the computer device, and FIG. 11 is a flowchart illustrating operation of the display device. FIGS. 12A and 12B are diagrams illustrating an example of screens displayed on the computer device and the display device of the present embodiment.

In the above described first embodiment, when the element is added to the display unit 16 of the computer device 10, the display image of the added element is generated and the data of the display image is transmitted to the display device 20, and then the display device 20 displays the added element based on the data of the display image. However, the added element does not necessarily need to be displayed in the display form similar to the display source. Thus, in the present embodiment, the computer device is controlled so as to transmit the file of the added element instead of transmitting the data of the display image the added element.

In this case, although the basic configuration of the shared-display system is similar to the above described first embodiment, a control unit 11 (a shared-display control unit 11b) of a computer device 10 adds, as needed, information to specify the display form (display information, such as page information or a display size) to a file of an added element determined to be related to a shared-display element by a relation determination unit 11a and transmits the file to a display device 20. Furthermore, a control unit 21 of the display device 20 is configured similarly to the computer device 10 so that an application operates on the OS. The control unit 21 (the shared-display control program which makes the control unit 21 function as the shared-display control unit) opens the file of the added element received from the computer device 10 with the application, set the display form based on the display information as needed, and displays the added element in the form similar to the computer device 10 as a display source.

Hereinafter, the operation of the computer device 10 having the above configuration will be described. A CPU 12 of the computer device 10 as the display source expands and executes, in a RAM 14, a shared-display control program stored in a ROM 13 or a storage unit 15, and whereby the CPU 12 executes the processing in each step illustrated in the flowchart of FIG. 10. Note that, in the following procedures, the element to be displayed will be described as the window.

While the shared display is being performed, when a new window is displayed on a display unit 16 of the computer device 10 as the shared-display source (Yes in S501), the control unit 11 (the relation determination unit 11a) determines the relation between the new window and the sharedly displayed window using the technique described in the first embodiment (S502). Then, when the new window is related to the sharedly displayed window (Yes in S503), the control unit 11 (the relation determination unit 11a) sets the new window to the shared display (lists the window in the shared-display list) (S504). Here, although the display image of the new window is generated in the first embodiment, in the present embodiment, the control unit 11 (the shared-display control unit 11b) specifies the display form of the new window (the display page or the display size) and transmits the file displayed on the new window and the display information to specify the display form of the file as needed to the display device 20 (or another computer device 10) as a shared-display destination (S505). Note that, similarly to the first embodiment, by displaying a pop-up screen before the new window is set to the shared display, the control unit 11 may allow a user to confirm whether or not the window is set to the shared display.

Next, the operation of the display device 20 (or another computer device 10) will be described. A CPU 22 of the display device 20 expands and executes, in a RAM24, a shared-display control program stored in a ROM 23 or a storage unit 25, and whereby the CPU 22 executes the processing in each step illustrated in the flowchart of FIG. 11. Note that, in the following procedures, the element to be displayed will be described as the window.

First, the control unit 21 acquires, similarly to the first embodiment, the data of the display image of the window set to the shared display via a communication I/F unit 28 from the computer device 10 as the display source (S601), and displays the window set to the shared display on a display unit 26 based on the acquired data of the display image (S602).

Thereafter, the control unit 21 determines whether the file and the display information as needed have been received (S603). Then, when the file and the like have been received, the control unit 21 generates the display images of the added window based on the received file and the display information as needed (S604), and displays the window newly set to the shared display on the display unit 26 based on the generated display image (S605). Then, the control unit 21 determines whether there is an instruction to terminate the shared display (S606), and monitors the reception of the file and the like until the instruction to terminate the shared display is received.

FIGS. 12A and 12B schematically illustrate the method for controlling the shared display according to the flowcharts of FIGS. 10 and 11. The left diagrams of FIG. 12A illustrate the screen of the display unit 16 of each computer device 10 as the display source (here, two computer devices 10). Rectangular frames in the screens indicate the elements (windows), and especially, rectangular frames in bold line indicate the windows set to the shared display (here, a window 1 and a window b). In this state, the window set to the shared display in the windows displayed on the display unit 16 of each computer device 10 is displayed on the display unit 26 of the display device 20 (or the display unit 16 of another computer device 10 set to the shared screen).

FIG. 12B illustrates that a new element (window) is added to the display unit 16 of the computer device 10 as the shared-display source. More specifically, a window 3, which is the document created with document creation software, is newly displayed on the display unit 16 of a first computer device 10. The window 3 is determined to be related to the window 1, set to the shared display, and also displayed on the display unit 26 of the display device 20 (or the display unit 16 of another computer device 10). At this time, the window 3 is displayed with the application which operates in the control unit 21 of the display device 20. Thus, when the types or versions of the application are different, the window 3 may be displayed in the different form from the computer device 10 as the shared-display source. However, in this case, the contents of the element (window) are substantially the same, and it is possible for the window 3 to be sharedly displayed. Here, the font used in the application which operates in the control unit 11 of the computer device 10 cannot be used in the application which operates in the control unit 21 of the display device 20, and FIG. 12B illustrates that the font is displayed with the substitute font.

As described above, with the configuration of the present embodiment, when the element is newly added to the display source, it is determined whether the element is related to the sharedly displayed element. Then, when the element is determined to be related, the added element is sharedly displayed on the display destination automatically. Therefore, the user does not need to set each element to the shared display and it is possible to remarkably improve the user's operability.

### Third Embodiment

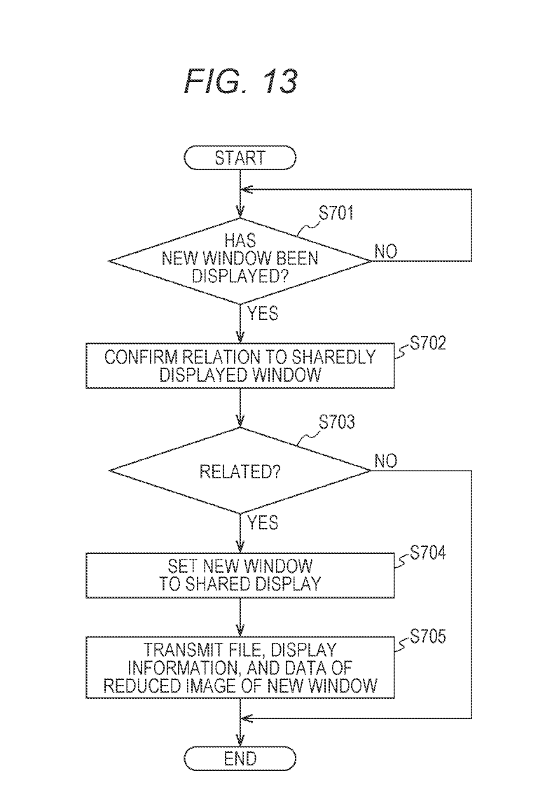

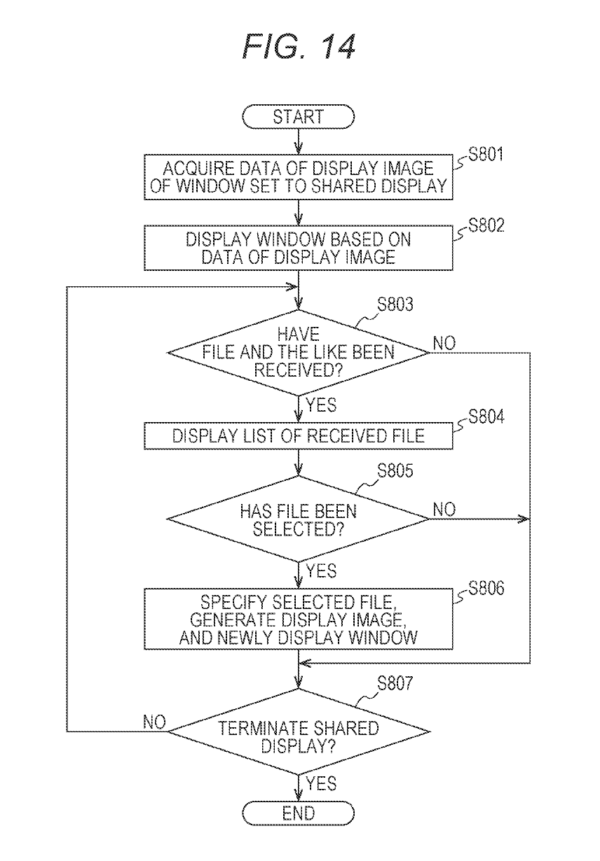

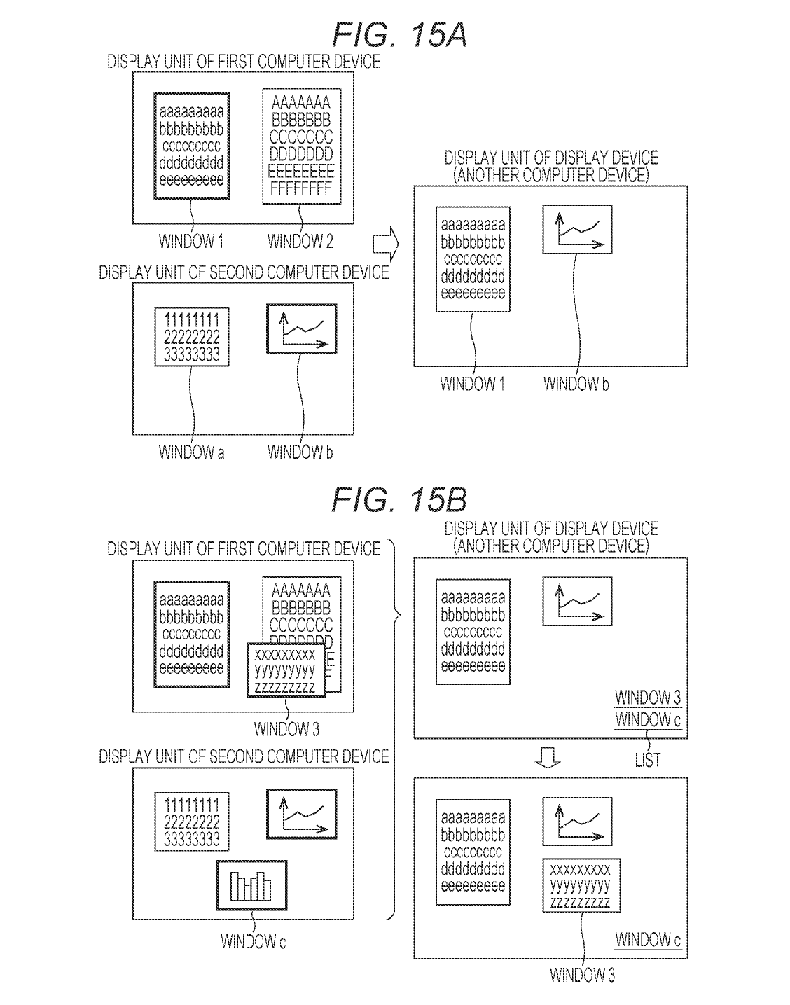

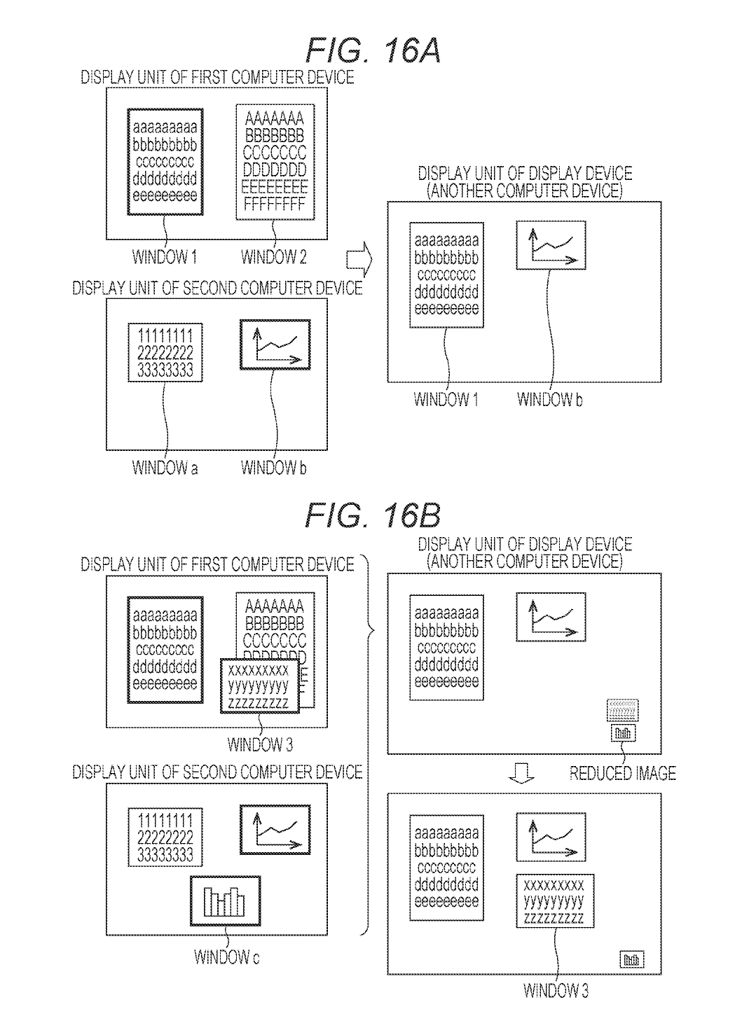

Next, a shared-display system and a shared-display control program, and a shared-display control method according to a third embodiment of the present invention will be described with reference to FIGS. 13 to 16. FIG. 13 is a flowchart illustrating operation of the computer device, and FIG. 14 is a flowchart illustrating operation of the display device. FIGS. 15 and 16 are diagrams illustrating an example of screens displayed on the computer device and the display device of the present embodiment.

The display device 20 displays the added element based on the data of the display image in the above described first embodiment, and the display device 20 generates the display image based on the file of the added element and the display information and displays the added element in the second embodiment. However, the added element does not necessarily need to be displayed as the image similar to the display source, and the added element is only required to be recognizable. Thus, in the present embodiment, the computer device is controlled so as to display the information which can specify the added element instead of displaying the added element as the image similar to a display source.

In this case, although the basic configuration of the shared-display system is similar to the above described first embodiment, a control unit 11 (a shared-display control unit 11b) of a computer device 10 transmits, to a display device 20, a file of an added element determined to be related to a shared-display element by a relation determination unit 11a and a reduced image data generated using display information as needed and the display image of the added element. Furthermore, a control unit 21 of the display device 20 is configured similarly to the computer device 10 so that an application operates on the OS. The control unit 21 (the shared-display control program which makes the control unit 21 function as the shared-display control unit) displays the information to specify the file of the added element (the file name or the reduced image), specifies the file of the added element corresponding to the selected information, opens the file with the application, sets the display form based on the display information as needed, and displays the added element in the form similar to the computer device 10 as the display source.

Hereinafter, the operation of the computer device 10 having the above configuration will be described. A CPU 12 of the computer device 10 as the display source expands and executes, in a RAM 14, a shared-display control program stored in a ROM 13 or a storage unit 15, and whereby the CPU 12 executes the processing in each step illustrated in the flowcharts of FIG. 13. Note that, in the following procedures, the element to be displayed will be described as the window.

While the shared display is being performed, when a new window is displayed on a display unit 16 of the computer device 10 as the shared-display source (Yes in S701), the control unit 11 (the relation determination unit 11a) determines the relation between the new window and the sharedly displayed window using the technique described in the first embodiment (S702). Then, when the new window is related to the sharedly displayed window (Yes in S703), the control unit 11 (the relation determination unit 11a) sets the new window to the shared display (lists the new window in the shared-display list) (S704). Then, the control unit 11 (the shared-display control unit 11b) specifies the display form of the new window (the display page or the display size), generates the reduced image of the new window and the like as needed, and transmits, to the display device 20 (or another computer device 10) as a shared-display destination, the file displayed on the new window, the display information to specify the display form of the file as needed, and the data of the reduced image as needed. (S705). Note that, similarly to the first embodiment, by displaying a pop-up screen before the new window is set to the shared display, the control unit 11 may allow a user to confirm whether or not the window is set to the shared display.

Next, the operation of the display device 20 (or another computer device 10) will be described. A CPU 22 of the display device 20 expands and executes, in a RAM24, a shared-display control program stored in a ROM 23 or a storage unit 25, and whereby the CPU 22 executes the processing in each step illustrated in the flowcharts of FIG. 14. Note that, in the following procedures, the element to be displayed will be described as the window.

First, the control unit 21 acquires, similarly to the first embodiment, the data of the display image of the window set to the shared display via a communication I/F unit 28 from the computer device 10 as the display source (S801), and displays the window set to the shared display on a display unit 26 based on the acquired data of the display image (S802).

Thereafter, the control unit 21 determines whether the file and, as needed, the display information or the reduced image data have been received (S803). Then, when the file and the like have been received, the control unit 21 creates a list, in which the file name and the like of the received file are listed, and displays the created list and received reduced image on the display unit 26 (S804). Then, when an operation unit 27 selects the file or the reduced image from the list (Yes in S805), the control unit 21 specifies the file corresponding to the selected file or the selected reduced image, generates the display images of the added window based on the specified file and the display information as needed, and displays, on the display unit 26, the window newly set to the shared display based on the generated display image (S806). Then, the control unit 21 determines whether there is an instruction to terminate the shared display (S807), and monitors the reception of the file and the like until the instruction to terminate the shared display is received.

FIGS. 15A and 15B schematically illustrate the method for controlling the shared display according to the flowcharts of FIGS. 13 and 14. The left diagrams of FIG. 15A illustrate the screen of the display unit 16 of each computer device 10 as the display source (here, two computer devices 10). Rectangular frames in the screens indicate the elements (windows), and especially, rectangular frames in bold line indicate the windows set to the shared display (here, a window 1 and a window b). In this state, the window set to the shared display in the windows displayed on the display unit 16 of each computer device 10 is displayed on the display unit 26 of the display device 20 (or the display unit 16 of another computer device 10 set to the shared screen).

FIG. 15B illustrates that a new element (window) is added to the display unit 16 of the computer device 10 as the shared-display source. More specifically, a window 3, which is the document created with the document creation software, is newly displayed on the display unit 16 of a first computer device 10, and a window c, which is the graph created with the spreadsheet software, is newly displayed on the display unit 16 of a second computer device 10. These windows are set to the shared display, and also displayed on the display unit 26 of the display device 20 (or the display unit 16 of another computer device 10). However, as illustrated in the upper right diagram, the images of the windows are not displayed as they are, but the list in which the file names to specify the file as the source of the document or the graph (here, the “window 3” and the “window c”) are listed, is displayed in the present embodiment. Then, when the “window 3” is selected from the list, the file corresponding to the file name is specified, and the specified file is displayed with the application which operates in the control unit 21 of the display device 20 as illustrated in the lower right diagram.

Furthermore, FIGS. 16A and 16B illustrate an example in which the reduced images are displayed instead of the list. As illustrated in the upper right diagram of FIG. 16B, the images of the window 3 and the window c are not displayed as they are, but the reduced images which can specify the documents and the graph are displayed. Then, when the reduced image corresponding to the “window 3” is selected from the reduced images, the file corresponding to the reduced image is specified, and the specified file is displayed with the application which operates in the control unit 21 of the display device 20 as illustrated in the lower right diagram.

As described above, with the configuration of the present embodiment, when the element is newly added to the display source, it is determined whether the element is related to the sharedly displayed element. Then, when the element is determined to be related, the information to specify the added element is displayed in the display destination. When the predetermined added element is selected, the selected added element is sharedly displayed on the display destination automatically. Therefore, the user does not need to set each element to the shared display and it is possible to remarkably improve the user's operability.

Note that, the present invention is not limited to the above embodiments, the configurations of the computer device 10 and the display device 20, and the control of the control unit can be appropriately changed without departing from the scope of the present invention.

For example, in the above embodiments, although a window as an element to be displayed has been exemplified, the element to be displayed is arbitrary.

Furthermore, although the file of the added element is transmitted to the display device 20 (or another computer device 10) in the above described third embodiment, the data of the display image of the added element may be transmitted similarly to the first embodiment. In this case, a file name capable of specifying the file of the added element is assigned to the data of the display image.

Furthermore, in the above described second and third embodiments, the display methods between the shared-display element set to the shared display in advance and the added element newly set to the shared display are different (the shared-display element is displayed based on the display image, and the added element is displayed based on the file). However, the shared-display element may be also displayed with the display method similar to the added element.

The present invention can be applied to a shared-display system in which a plurality of devices can display information, a shared-display control program which operates in the system, a recording medium storing the shared-display control program, and a shared-display control method in the system.

Although embodiments of the present invention has been described and illustrated in detail, it is clearly understood that the same is by way of illustrated and example only and is not to be taken by way of limitation, the scope of the present invention being interpreted by terms of the appended claims.

1. A shared-display system in which a plurality of devices including at least a display unit is connected each other via a communication network, wherein
a first device in the plurality of devices comprises:
a control unit which sets each element to shared display in which an element displayed on a display unit of the first device is displayed on another device, and
when an added element is displayed on the display unit of the first device, the control unit determines whether the added element is related to a shared-display element which has been set to the shared display, sets, to the shared display, the added element determined to be related to the shared-display element and displays the added element on a display unit of the other device.

2. The shared-display system according to claim 1, wherein
the control unit generates a display image of the added element determined to be related to the shared-display element and transmits data of the display image to the other device, and
the other device displays the added element on the display unit of the other device based on the received data of the display image.

3. The shared-display system according to claim 1, wherein
the control unit of the first device displays the added element by operating an application, and transmits, to the other device, a file of the added element determined to be related to the shared-display element, and
the other device displays the added element on the display unit of the other device by opening the received file of the added element with the application.

4. The shared-display system according to claim 1, wherein
the control unit of the first device displays the added element by operating an application, and transmits, to the other device, a file of the added element determined to be related to the shared-display element, and
the other device displays information capable of specifying the received file of the added element on the display unit of the other device and displays the added element on the display unit of the other device by opening, when the information is selected by an operation unit, the file of the added element corresponding to the selected information with the application.

5. The shared-display system according to claim 4, wherein
the information capable of specifying the file of the added element is a file name of the file of the added element or a reduced image of the display image of the added element.

6. The shared-display system according to claim 5, wherein
by operating the file name of the file of the added element or the reduced image of the display image of the added element, an image corresponding to the file or the reduced image is displayed.

7. The shared-display system according to claim 1, wherein
the first device or a server connected via the communication network includes a storage unit which classifies and store a file of an element in a folder or a drive, and
the control unit of the first device determines that the added element is related to the shared-display element when the file of the added element is stored in the same folder storing the file of the shared-display element if determining according to a folder, and when the file of added element is stored in the same drive storing the file of the shared-display element if determining according to a drive.

8. The shared-display system according to claim 1, wherein
when the file names of the files of the added element and the shared-display element include the same keyword, the control unit of the first device determines that the added element is related to the shared-display element.

9. The shared-display system according to claim 1, wherein
when an access right is set to each element, and an access right of the added element is matched with an access right of any of the shared-display element or includes an access right of any of the shared-display element, the control unit of the first device determines that the added element is related to the shared-display element.

10. The shared-display system according to claim 1, wherein
when the added element is an element displayed based on link information set to the shared-display element, the control unit of the first device determines that the added element is related to the shared-display element.

11. The shared-display system according to claim 1, wherein
when the added element is an element searched for using a keyword included in the shared-display element, the control unit of the first device determines that the added element is related to the shared-display element.

12. The shared-display system according to claim 1, wherein
when display positions of the added element and the shared-display element are within a distance range set in advance, the control unit of the first device determines that the added element is related to the shared-display element.

13. The shared-display system according to claim 1, wherein
when display times of the added element and the shared-display element are within a time range set in advance, the control unit of the first device determines that the added element is related to the shared-display element.

14. The shared-display system according to claim 1, wherein
before the added element is set to the shared display, the control unit of the first device display a screen to confirm a user whether or not the added element is set to the shared display.

15. A non-transitory recording medium storing a computer readable shared-display control program which operates in a first device in a plurality of devices in a shared-display system in which the plurality of devices including at least a display unit is connected each other via a communication network,
wherein the program causes the first device to execute:
processing of setting each element to shared display in which an element displayed on a display unit of the first device is displayed on another device;
processing of determining, when an added element is displayed on the display unit of the first device, whether the added element is related to a shared-display element which has been set to the shared display; and
sharing processing of setting, to the shared display, the added element determined to be related to the shared-display element and displaying the added element on a display unit of the other device.

16. The non-transitory recording medium storing a computer readable shared-display control program according to claim 15, wherein the program causes the first device to further execute:
processing of displaying the added element by operating an application and transmitting, to the other device, a file of the added element determined to be related to the shared-display element.

17. A shared-display control method in a shared-display system in which a plurality of devices including at least a display unit is connected each other via a communication network, the method comprising:
executing, by a first device in the plurality of devices, processing of setting each element to shared display in which an element displayed on a display unit of the first device is displayed on another device;
executing, by the first device, processing of determining, when an added element is displayed on the display unit of the first device, whether the added element is related to a shared-display element which has been set to the shared display;
executing, by the first device, processing of setting, to the shared display, the added element determined to be related to the shared-display element and transmitting, to the other device, data of a display image of the added element or a file of the added element; and
executing, by the other device, processing of displaying the added element on a display unit of the other device based on the received data of the display image of the added element or the received file of the added element.

18. The shared-display control method according to claim 17, further comprising:
executing, by the first device, processing of displaying the added element by operating an application and transmitting, to the other device, the file of added element determined to be related to the shared-display element.

19. An information shared-display device used as a first device in a plurality of devices in a shared-display system in which the plurality of devices including at least a display unit is connected each other via a communication network, the information shared-display device comprising:
a display unit;
a communication unit; and
a control unit which sets each element to shared display in which an element displayed on a display unit of the information shared-display device is displayed on another device, wherein
when an added element is displayed on the display unit of the information shared-display device, the control unit determines whether the added element is related to a shared-display element which has been set to the shared display, sets, to the shared display, the added element determined to be related to the shared-display element and displays the added element on a display unit of the other device.

20. The information shared-display device according to claim 19, wherein
the control unit displays the added element by operating an application and transmits, to the other device, a file of the added element determined to be related to the shared-display element.
